(19) United States
(12) Patent Application Publication
(10) Pub. No.: US 2004/0134444 A1
(43) Pub. Date: Jul. 15, 2004

(54) Folding aluminum dog box having knockdown walls

(76) Inventors: Andre Z. Shiever, Salina, KS (US); Rosemary Anne Shiever, Salina, KS (US)

Correspondence Address: Richard C. Litman, LITMAN LAW OFFICES, LTD., P.O. Box 15035, Arlington, VA, 22215, US

(21) Appl. No.: 10/743,292

(22) Filed: Dec. 23, 2003

Related U.S. Application Data
(60) Provisional application No. 60/437,754, filed on Jan. 3, 2003.

(51) Int. Cl. A01K 1/03

(52) U.S. Cl. 119/496

(57) ABSTRACT

A lightweight, rectilinear, aluminum knock down dog box of attachable panels which store on suspension hooks. Each of six panels has an internal frame of square aluminum tubing. Each panel has rigid insulation between frame members and is covered by an aluminum alloy sheet skin on an interior side, and by either an aluminum alloy sheet or a polyvinyl chloride sheet on an exterior side. Adhesive bonds the skin to the internal frame and rigid insulating foam. Hinge halves connect the panels by pins vertically at each wall corner and clips at the top and bottom. The front panel has a vertically swingable, latched and lockable cage door. Sealing strips are used at panel joints and a sliding panel is installable for winter. Louvered ventilator panes are installed in the sidewalls and rear wall, the panes being supported by metal angle segments attached to the internal frame members.

### CROSS-REFERENCE TO RELATED APPLICATION

This application claims the benefit of U.S. Provisional Patent Application Serial No. 60/437,754, filed Jan. 3, 2003.

### BACKGROUND OF THE INVENTION

1. Field of the Invention

The present invention relates to animal carriers. More particularly, the invention relates to an aluminum dog box having knockdown walls, floor, and top, the front wall having a lockable cage door which is upward rotatable for ingress and egress of a dog, the knockdown components being compactly storable by hanging on suspension hooks.

2. Description of Related Art

It is known to provide portable pet carriers such as for dogs, which are foldable or subject to knockdown for storage. These carriers lack insulation for keeping the pet warm and are not necessarily suitable for outdoor, fixed use over a period of time while being sufficiently light to easily move by one or two persons while providing adequate space for the comfort of the dog. It would be desirable to provide a portable pet carrier such as for a large dog which is built for roominess, lightness, and durability and is useful in an outside environment over an extended time. It would also be desirable to provide such a dog carrier which may be easily broken down into its walls, top, and base which may be compactly stored by hanging on suspension hooks.

U.S. Pat. No. 6,152,081, issued Nov. 28, 2000 to Baker, describes a quasi-stable dog kennel consisting of a solid bottom panel and four wall frames. Each frame is made of two square tubing sidebars and a plurality of equally spaced, vertically supporting bars which are integrally formed with the sidebars. The four frames form a cage-like enclosure for confining a domestic dog. The frames are not connected by means of half-hinges, with pins or clips.

U.S. Pat. No. 3,604,590, issued Sep. 14, 1971, to Jenkins, describes a chicken coop made of square aluminum tubing and including a bottom and top horizontal frames. A plurality of spaced apart square aluminum tubing forms the sidewalls. A perforate sheet material is employed for covering the four sides of the enclosure.

U.S. Pat. No. 5,803,018, issued Sep. 10, 1977, to Liou, describes a portable, knock down pigeon cage with a rectangular internal space defined by four wall panels, a solid bottom panel and a top panel. The cage is divided into a hinged top and bottom portions, the hinging mechanisms enabling the cage to collapse and align with the bottom portion. The half-hinges which enable the top portion of the cage to collapse into the bottom portion are screwed onto the side of the two cage portions.

U.S. Pat. 1,669,300, issued May 8, 1928 describes a knock down receptacle made of a plurality of side panels. The ends of the panels are formed into hinge elements adapted to be aligned and stabilized by bolts. When the bolts are withdrawn from the hinges, the panels can be disassembled and packed flat for storage.

U.S. Pat. No. 5,943,982, issued Aug. 31, 1999, to Askins et al., describes a collapsible pet home having a base, side walls, end walls, and a roof which can be converted into an exercise pen of the pet by folding the end walls down into the base, setting the base on end, and using the base, side walls, and roof to form the peripheral walls of the pen. An additional pen-forming module is provided to connect with the roof, one side, and one of the sidewalls on the other side to complete the peripheral wall of the exercise pen.

None of the above inventions and patents, taken either singly or in combination, is seen to describe the instant invention as claimed.

### SUMMARY OF THE INVENTION

The present invention is a high quality, lightweight, aluminum dog box which completely disassembles and stores flat for transportation and storage purposes. The dog box includes a plurality of panels, each panel having an internal frame assembly of square aluminum tubing, and forming the bottom, the four walls, and the ceiling of the box. Each panel is fully insulated between frame members and is covered on the inside by aluminum alloy sheet, and covered on the outside by aluminum or polyvinyl chloride (PVC) sheet, forming the skin of the panel. High strength industrial grade adhesive is employed for bonding the aluminum/PVC sheets to the internal frame assembly and rigid insulating foam.

Hinge halves are used for connecting the panels together, two pairs of hinge halves being attached by pins vertically at each wall corner and the top and bottom are attached by sets of pairs of hinge halves attached by clips. The front panel has a vertically swingable, latched and lockable cage door which may be fixed in the open position for entry or exit of the dog. The walls are first assembled by vertical pins into a rectangle, the rectangle is clipped to the base, and the top may be clipped to the rectangle by reaching inside the cage door. The roof overhangs the sidewalls to allow rain to drip over the sides. The sides overhang the bottom panel to allow rain to drip off the assembly. Sealing strips are used at panel joints to maintain a secure, pleasant environment. A sliding panel is installable in grooves partially surrounding the cage doorframe to cover the open cage door for warmth during winter, the panel having air holes for ventilation. Louvered ventilator panes are installed in the sidewalls and rear wall, the panes being supported metal angle segments which are attached to the members of the internal frame members. The inventive dog carrier may be easily disassembled, each panel having ‘D’-clips for hanging on storage hooks when not in use.

Accordingly, it is a principal object of the invention to provide an enclosed dog carrier which is light in weight, durable, and easily assembled and disassembled for storage.

It is another object of the invention to provide a dog carrier box as above using aircraft-type construction techniques to form side, top and base panels for strength and lightness.

It is a further object of the invention to provide a dog carrier box as above which can be easily carried by one or two persons, depending on size of the carrier and the dog.

Still another object of the invention is to provide a dog carrier box as described which has an easily opened and closed, lockable cage-type door having a plastic panel cover for cold weather.

Yet another object of the invention is to provide a dog carrier box as described which has louvered panels in side and end wall panels for ventilation.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a perspective view of an aluminum dog box having knockdown walls according to the present invention.

FIG. 2 is a perspective view of the dog box of FIG. 1 having the front grate in an open and secured position and leveling feet exploded away.

FIG. 3 is a perspective view of the dog box of FIG. 1 illustrating the installation of a winter closure panel.

FIG. 4 is an internal perspective view of the dog box of FIG. 1 illustrating the half-hinge assembly elements as held by vertical pins and horizontal clips.

FIG. 5 is a perspective, cutaway view illustrating the internal construction of a panel.

FIG. 6 is a perspective view of storage hooks for hanging the disassembled dog box panels for storage featuring the storage of the top panel.

Similar reference characters denote corresponding features consistently throughout the attached drawings.

### DETAILED DESCRIPTION OF THE PREFERRED EMBODIMENT

The present invention is a high quality, insulated dog carrier or box which may house a dog for an extended time and is designed to be useful out of doors in the weather. The dog carrier or box is of aerospace type construction for maximum strength and lightness.

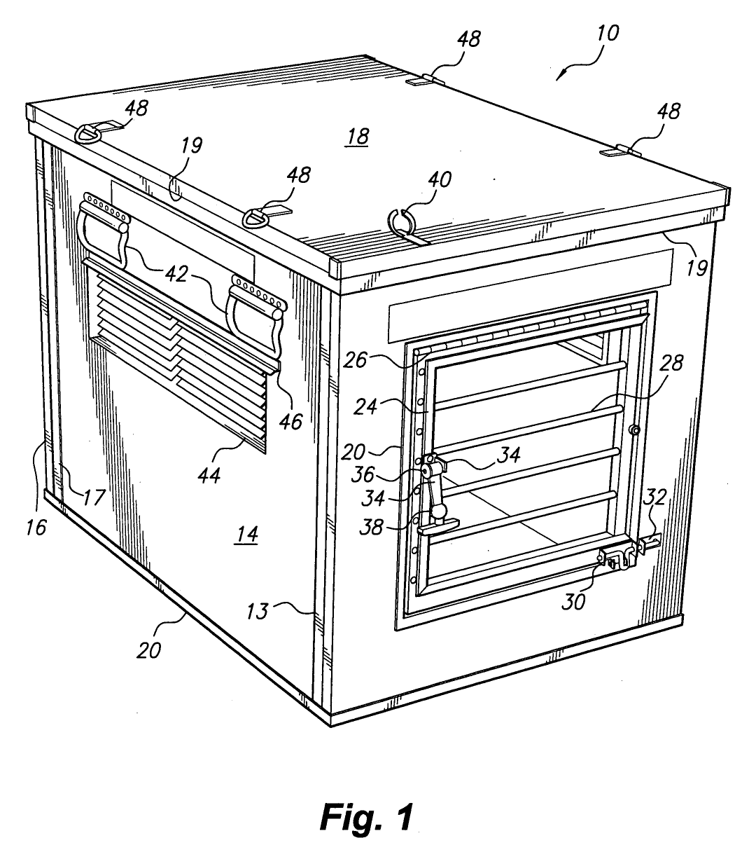

Referring to FIGS. 1-3, there is shown a perspective view of the assembled aluminum dog box having knockdown walls of the present invention, generally designated by the reference number 10. Dog box 10 is rectilinear in shape when assembled and includes a front panel 12 with front panel overlaps 13 overlapping each respective side panel 14 along their respective vertical front edges. The dog box 10 also has a rear panel 16 with rear panel overlaps 17 overlapping each side panel 14 along their respective vertical rear edges. Overlaps 13 and 17 are angle segments attached to the inner surfaces of front panel 12 and rear panel 16 along the vertical edges thereof. The dog box 10 has a top panel 18 having edges 15 and covering the assemblage of front panel 12, side panels 14, and rear panel 16 and overlapping the upper edges of the assemblage by means of a top overlap 19. Top overlap 19 is spaced from the front, side, and rear panel upper edges to act as rain drip edges and may conveniently be made of metal angle sections extending along the four edges of the top panel 18. The rectangular assemblage of front, side, and rear panels 12, 14, and 16 rests on a base panel 20.. All panels are preferably of aluminum construction using aerospace assembly techniques as further described below.

Front panel 12 includes a rectangular entrance frame 22 centrally located therein and defining an opening for entrance and exit of a dog or other animal to be housed therein. A framed grate 24 is hung by a piano-type hinge 26 along its upper edge from the upper edge of the entrance frame 22, allowing the framed grate 24 to be opened or closed by swinging upwardly and downwardly, respectively. Framed grate 24 is open to the exterior, having grate bars 28 extending crosswise to restrain the animal inside from escaping the box. A lockable slide bar latch 30 with cooperating keeper 32 or the like is disposed along the lower right edge of framed grate 24 and may be secured with a padlock.

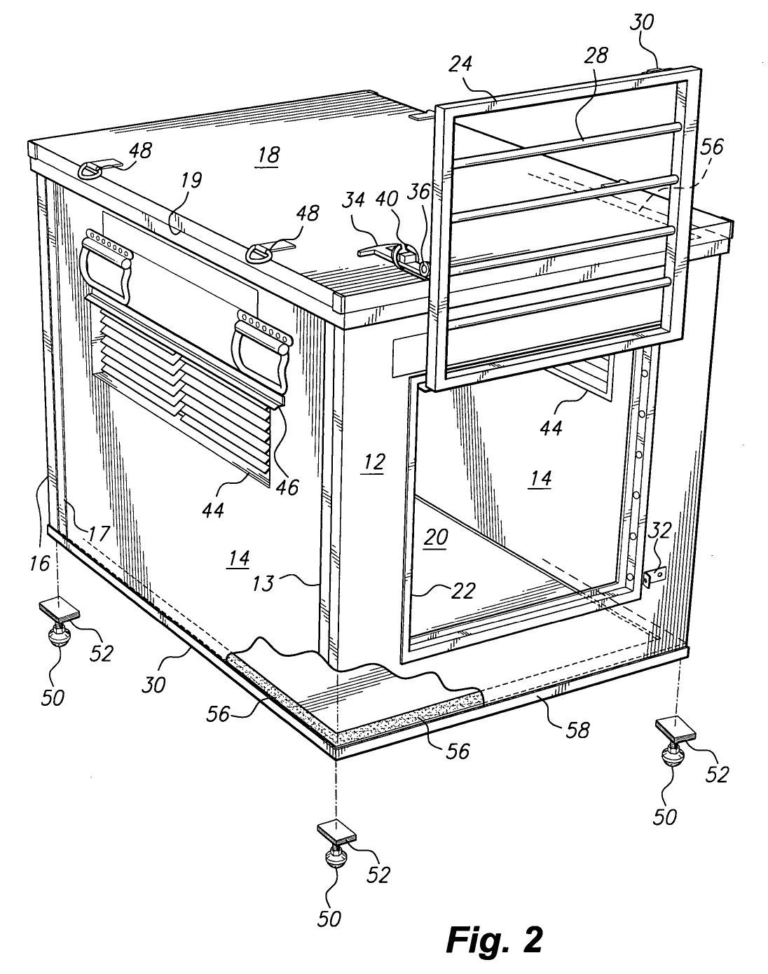

Framed grate handle 34 is located at a convenient height along the left edge of the frame 24. Grate handle 34 is generally cylindrical in form having a grate handle pivot 36 allowing grate handle 34 to pivot between a vertically downward position at rest (see FIG. 1) to an upward position(see FIG. 2). The grate handle 34 has a cross piece 35 at its extreme end for the user to grasp. At a point along the handle, a grate handle-securing bulb 38 is positioned. The bulb 38 cooperates with a receiver 40 as is more clearly seen in FIG. 2. To maintain the framed grate 34 in an open position, the securing bulb 38 snaps over securing bulb receiver 40 secured to the top panel 18. Spacer 39, an inner projection, keeps handle 34 spaced away from frame 24 when handle 34 is hanging vertically to aid in grasping cross piece 35.

A pair of sidewall handles 42 are located on each side panel 14 spaced apart and centrally mounted in a convenient location near the top of each side panel 14 such that a person on each side of the dog box can easily lift and carry the box as desired with minimum effort. Sidewall louvered ventilators 44 are installed in each side panel 14, preferably immediately below the level of handles 42 to allow cross ventilation through the box. Another ventilator 44 may be similarly installed in rear panel 16 (not shown) for additional ventilation. Ventilator drip edges 46 extend outward over the upper edge of ventilators 44 and may conveniently be a zee angle piece with one of the surfaces adhered to the panel while the other surface provides cover from rain, etc., for louvered ventilators 44, this being typical for all louver locations, i.e., the two side panels 14 and the rear panel 16.

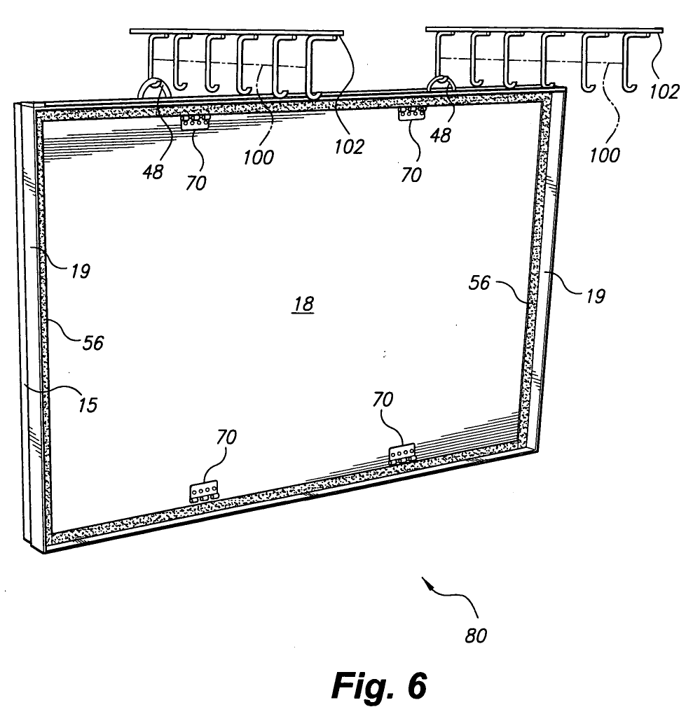

Spaced pairs of D-ring clips 48 (some not shown) are located along the peripheral edges of each side of top panel 18, base panel 20, front panel 12, rear panel 16, and side panels 14 for use in hanging the disassembled panels, as described with reference to FIG. 6, below. Each pair of D-rings are spaced the same distance apart, regardless of the width of the panel, so they match storage hangers.

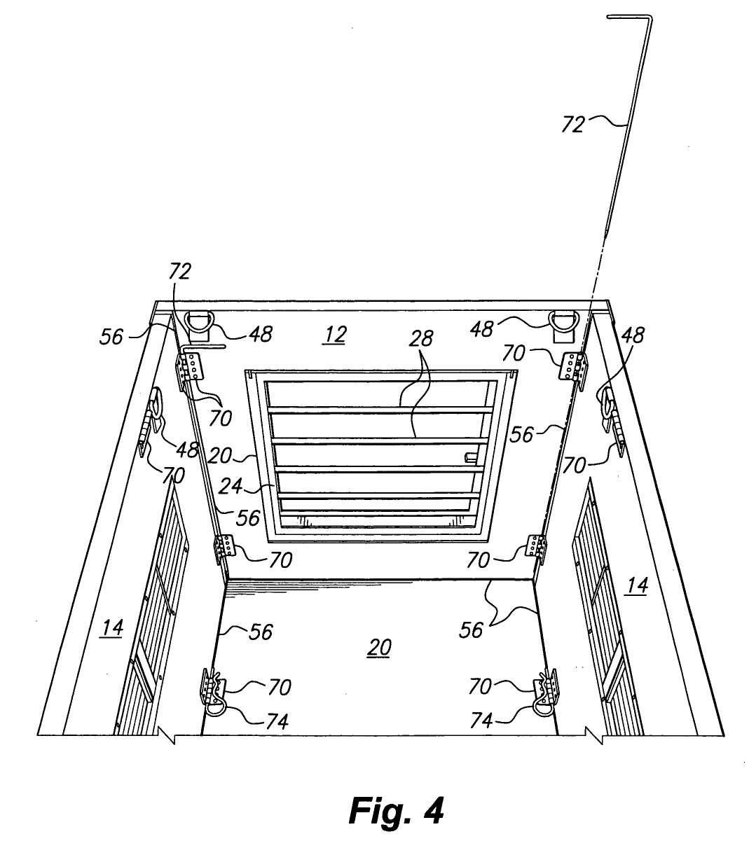

As seen in FIG. 2, framed grate 24 is held in a vertically upward position by means of grate handle 34 being engaged with securing bulb receiver 40. Also shown exploded away from box base panel 20 are leveling feet 50 fixed to panel 20, such as by adhesive, rivets, or welding, by foot pads 52 located near each respective corner of base panel 20, and which are adjustable in length so as to level the dog box by twisting the screw portions of the leveling feet 50 relative to pads 52. The lower walls of front panel 12 and side panel 14 are cut away to show insulation strips 56 extending around the periphery of the upper side of base panel 20. Metal angle segments 60 are installed on the bottom edges of panels 14, 16, and 12. The metal angle segments 60, in turn, seal against the insulation strips 56, which are installed along the periphery of base panel 20 and spaced from panel edges 58, forming drip edges for weather resistance in a manner similar to top 18. Insulation strips 56 are similarly installed around the periphery of the lower side of top panel 18 inside top panel lip 19 to seal against the upper edges of panels 12, 14, and 16 for weather resistance. Insulation strips 56 are also installed vertically along the inner vertical edges of front panel 12 and rear panel 16 within front panel overlap 13 and rear panel overlap 17 to seal against the front and rear vertical edges of side panels 14 for weather resistance(see FIG. 4).

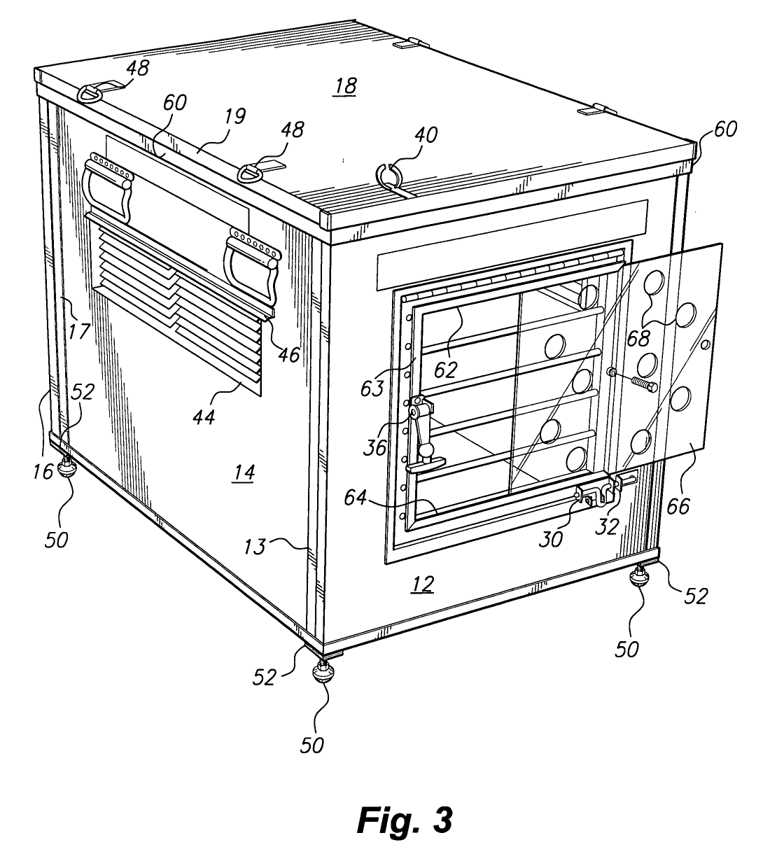

As is seen in FIG. 3, grate frame upper slot 62, end slot 63, and lower slot 64 extend outward from the grate frame 22 to receive a cold weather closure panel 66 having air holes 68 as by sliding to a desired point and securing in place with cold weather closure panel securing screw 67 through perforation 69 to provide added comfort to the animal during winter months.

Referring to FIG. 4, there is shown a perspective internal view of the dog carrier or box 10 with the top panel 18 removed. Pairs of mating half-hinges 70 are spaced along each inner edge of side panels 14, the side edges of base panel 20, the top panel 18, and the vertical edges of rear panel 16 and the front panel 12. Upon assembly, pins 72 are run down through the mated half-hinges 70 at either side of front panel 12 and rear panel 16 (not shown), securing them to side panels 14. The joined sides are then placed on base panel 20 and half-hinges 70 along each side of base panel 20 such that half-hinges 70 mate and clips 74 are inserted through the mated half-hinges 70, thereby securing the base panel 20 to the lower edges of side panels 14. The top panel 18 (not shown) has half-hinges 70 along its inner sides in a manner identical to those of base panel 20. These half-hinges 70 are mated with half-hinges 70 along the upper edges of side panels 14 and, by opening the framed grate 24, the assembler may insert clips 74 through the mated half-hinges 70. The dog carrier or box is then ready for use. The dog box may be disassembled by following a reverse procedure.

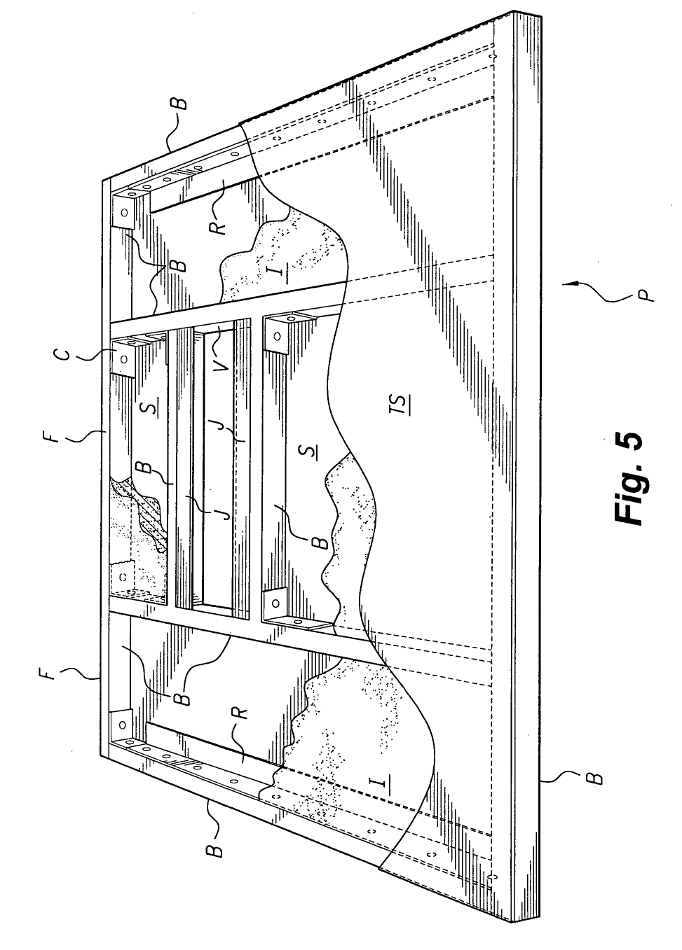

Referring to FIG. 5, there is shown a cutaway perspective view of a panel P, such as a back panel 16, as used in the present invention. Panel P includes a frame F of joined beams B. An aluminum alloy sheet skin S is sized as desired. Frame F has peripheral and internal beams B joined by riveted corner supports C, or alternatively by welding, and joined to the skin S by adhesive.

Metal angle segment reinforcements R are attached to the vertical members B of frame F. As shown in FIG. 5, metal angle segment jambs J are attached to the horizontal members of ventilator rectangle V as shown in FIG. 5 to receive louvered ventilators 44.

For side panels 14, the hinge halves 70 are permanently secured to the side panels 14 by way of rivets that are installed through half-hinges 70, side panel skin S, and metal frame F, as shown in FIG. 4.

For back panel 16 and front panel 12, the half hinges 70 are permanently secured to the front and back panels 16 and 12, respectively by way of rivets that are installed through half-hinges 70, back panel skin S or front panel skin S and metal angle segments R which are attached to vertical members B of frame F as shown in FIG. 4. Internal pockets formed by the frame are filled with fitted rigid insulation foam I and joined to skin S by adhesive.

The ventilator rectangle V has metal angle segments acting as jambs J, as shown in FIG. 4, attached by way of rivets or welding to act as a receiver for the louvered ventilators 44. This is common to all ventilator rectangles V for side panels 14 and back panel 16. The top skin TS is then attached to the resulting foam filled frame of joined beams B by adhesive to form a strong, lightweight panel.

The half-hinges 70 are permanently secured to the side panels 14 by way of rivets that are installed through half-hinges 70, side panel skin S, and metal frame F. Internal pockets formed by the frame are filled with fitted rigid insulation foam I and joined to skin S by adhesive. The ventilator rectangle V is left open to receive louvered ventilators 44. The top skin TS is then attached to the resulting foam-filled frame of joined beams B by adhesive to form a strong, lightweight panel.

FIG. 6 shows a hanging device for hanging the various panels of the knockdown dog box. The hanging device is a pair of flat metal bar segments 102, each having a column of six spaced hangers 100 permanently affixed thereto. The hangers 100 extend downward from the metal bar segments 102 and support the various panels of the knockdown dog box, such as top panel 18 shown, from pairs of “D”-rings 48. The bar segments 102 are positioned parallel, in such manner that the hangers 100 are laterally aligned. Each of the six panels can then be hung from a pair of opposing hangers, thus providing compact storage of the panels when not in use. The bottom side of top 18 is shown stored, illustrating edges 15 and segment overlaps 19 on which peripheral insulation strips 56 are mounted for sealing engagement with the upper edges of front panel 12, side panels 14, and rear panel 16.

It will be understood by those skilled in the art that other arrangements of hangers or hooks may be used for storage of the dog box. For example, the hangers 100 may be supported by L-shaped brackets, each L-shaped bracket having a mounting arm secured to a wall or other vertical support surface, with a column of three hangers suspended from the projecting arm of each L-shaped bracket. Four such units may be mounted in two pairs, so that three dog box panels may be suspended from each pair of brackets using the “D”-rings 48. In some configurations, this arrangement may provide for more compact storage than the two segments 102 of six hangars 100 shown in FIG. 6.

The insulation employed in the construction of the panels is preferably ¾″ pink board. The panels are preferably covered with 0.040″ 3003H14 aluminum sheeting on the interior of each panel assembly, and 1/16 inch PVC or aluminum sheeting on the exterior of each panel assembly, using high strength industrial grade adhesive. The winterization panel is preferably ⅛″ plexiglass sheet with 1″ holes to improve heat retention by the animal while providing air ventilation. Insulation sealing strips 56 are of EPDM Sponge Seal to make the box weatherproof. Drip edges are provided as described above at the periphery of the top panel 18, along the bottom edge of each side panel 14, the back panel 16, and the front panel 12, and above the louvers 44, to keep rain water from draining into the box interior.

It is to be understood that the present invention is not limited to the sole embodiment described above, but encompasses any and all embodiments within the scope of the following claims.

We claim:

1. A folding dog box assembly comprising:
a top panel;
two side panels;
a rear panel;
a base panel; and
a front panel;
said front panel having an entrance frame therein and a framed grate pivotally mounted above said entrance frame for opening and closing said framed grate relative to said entrance frame;
said framed grate having a lockable closure latch at its base, and said front panel having a latch keeper mounted thereon cooperating with the closure latch;
each of said panels having an inner peripheral edge and spaced pairs of half-hinges along the inner peripheral edge; and
means for mating the half hinges together, thereby securing said panels to form a closed dog box.

2. The dog box of claim 1, wherein said side panels and said rear panel each have a louvered ventilator therein.

3. The dog box of claim 1, wherein said panels define internal pockets, the dog box further comprising foam insulation filling the pockets.

4. The dog box of claim 1, wherein each of said panels comprises a plurality of beams defining a panel frame having pockets, the dog box further comprising foam insulation filling the pockets.

5. The dog box of claim 4, wherein said panels further comprise an inner skin made from aluminum alloy sheet adhesively attached to said panel frame.

6. The dog box of claim 4, wherein each said panel frame has an exterior side and an interior side, each said panel frame further comprising an aluminum alloy sheet skin covering the interior side and an outer skin covering the exterior side, the outer skin being selected from the group consisting of an aluminum alloy sheet skin and a polyvinyl chloride (PVC) sheet skin.

7. The dog box of claim 4, wherein said side and rear panels each further comprise a plurality of beams disposed within the panels frames defining a rectangular ventilator opening having a top beam and a bottom beam, and a pair of angles having a first flange attached to the top and bottom flanges, respectively, and a second flange extending into the ventilator opening to form top and bottom ventilator jambs, respectively, the dog box further comprising a louvered ventilator inserted into the ventilator openings of said side and rear panels and abutting the ventilator jambs.

8. The dog box of claim 1, wherein said framed grate further comprises an upper slot, an end slot, and a lower slot extending outward from the framed grate.

9. The dog box of claim 8, further comprising a cold weather closure panel having air holes defined therein, the closure panel being slidably received in said framed grate slots.

10. The dog box of claim 1, wherein said front and rear panels each have an inner surface and vertical edges, the dog box further comprising a plurality of angles having a first flange attached to the inner surfaces of said front and rear panels along the vertical edges thereof, and a second flange overlapping the side panels vertically.

11. The dog box of claim 10, wherein said top panel has a bottom surface and a periphery, the dog box further comprising a plurality of angles the periphery of the bottom surface of said top panel, each said angle having a flange overlapping the front, side, and rear panels.

12. The dog box of claim 1, further comprising a louvered ventilator disposed in at least one of said panels, the ventilator having a drip edge forming an awning above the ventilator in order to prevent rain from entering the dog box through the ventilator.

13. The dog box of claim 1, further comprising at least one handle mounted on each said side panel.

14. The dog box of claim 1, further comprising a plurality of height adjustable feet mounted underneath said base panel.

15. The dog box of claim 1, further comprising a plurality of insulation strips extending around said base panel, said top panel, and said front and rear panels.

16. The dog box of claim 1, further comprising a handle pivotally mounted on said framed grate.

17. The dog box of claim 16, wherein said handle is generally cylindrical, having a first end having an aperture defined therein and a second end, the handle further including:
a pivot pin extending through the aperture in the first end;
a cross piece disposed on the second end;
a securing bulb positioned along the handle cooperating with a receiver disposed on the top panel when the grate is in an open position; and
a spacer disposed on the handle in order to keep the handle spaced away from the framed grate when the handle is hanging vertically in order to aid in grasping the cross piece.

18. A folding dog box assembly, comprising:
a top panel;
two side panels;
a rear panel;
a base panel; and
a front panel, having an entrance frame defined therein;
a framed grate pivotally mounted above the entrance frame for opening and closing the framed grate relative to the entrance frame;
a louvered ventilator disposed in each of the side panels and in the rear panel;
a lockable closure latch attached to the framed grate and a cooperating latch keeper attached to the front panel adjacent the entrance frame;
a plurality of spaced pairs of half-hinges attached to each of the panels; and
means for joining the half-hinges in order to secure the panels to form a closed dog box.

19. The dog box of claim 18, wherein each of said panels comprises:
a plurality of beams joined together to define a rectangular panel frame having an interior side and an exterior side;
an aluminum alloy sheet attached to and covering the interior side of the panel frame and forming an inner skin;
a sheet selected from the group consisting of an aluminum alloy sheet and a polyvinyl chloride sheet attached to and covering the exterior side of the panel frame and forming an outer skin; and
foam insulation disposed in the panel frame between the inner skin and the outer skin.
